(19) United States
(12) Patent Application Publication
(10) Pub. No.: US 2005/0189301 A1
(43) Pub. Date: Sep. 1, 2005

(54) Oily waste treatment process

(76) Inventors: Paul Charles Wegner, San Carlos, CA (US); Peter John Webster, Alameda, CA (US)

Correspondence Address: BENASUTTI, P.A., 17294 BERMUDA VILLAGE DRIVE, BOCA RATON, FL, 33487, US

(21) Appl. No.: 11/067,380

(22) Filed: Feb. 25, 2005

Related U.S. Application Data
(60) Provisional application No. 60/547,448, filed on Feb. 26, 2004.

(51) Int. Cl. C02F 1/52

(52) U.S. Cl. 210/724

(57) ABSTRACT

The removal of oils, fats, and proteins from various industrial process streams containing these materials; such as dairy, cheese, whey, meat, fish, and vegetable process streams is accomplished by adding a mixture of sulfuric or phosphoric acid with calcium or magnesium phosphate or sulfate to the waste water to adjust the pH of the waste water to less than 7; and then separating the resulting solids from the liquid in the waste water; and adjusting the pH of the solids and liquid to make them acceptable waste products having a pH of 6-9.

### CROSS REFERENCE TO RELATED APPLICATION

This application is a continuation-in-part of our prior co-pending provisional application No. 60/547,448, filed Feb. 26, 2004, entitled: “Food processing waste treatment”; the disclosure of which is incorporated herein by reference as if fully set forth; and we claim the benefit of the filing date of that application.

### BACKGROUND OF THE INVENTION

Prior Art

Many food-processing operations require regular cleaning of process equipment with various chemicals. The wastewater generated from the wash process can have high fat or protein levels, which make the water difficult to process in water treatment plants due the high Biological Oxygen Demand (BOD) and Chemical Oxygen Demand (COD) levels.

It is desirable to achieve the following in such processes:
remove the fat and protein without degrading their potential value as a food source;
minimize the use of chemicals which add weight to the product;
use chemicals which add to the value of the product;
use chemicals which have the least environmental impact on the treated water;
allow simple separation of the solids from the liquid phase; and
substantially reduce the COD level of the liquid phase.

### DETAILED DESCRIPTION OF THE INVENTION

In accordance with our invention, the process comprises the following steps:

1. Adjusting the pH to less than 7 with an acid. The preferable pH is 5 to 3. Preferably sulfuric, phosphoric, or lactic acid is used. The salts described in step 2 can be incorporated in the acid solution.

2. Adding a calcium or magnesium salt. Preferably a calcium or magnesium salt with a polyvalent anion such as sulfate or phosphate

3. Separating the solids from the liquid phase. The separation is preferably done with a centrifuge. The most preferable centrifuge is a Sedicanter®. This is the product of a German company, Flotweg, and is most preferred because it can remove solids that are known in the art as “slippery”. The use of a Sedicanter®, high speed vertical disc clarifier, solid bowl, or horizontal scroll discharge decanter centrifuge improves the quality of the solid and liquid phase by providing a cleaner separation of the two phases on a continuous basis.

Flocculating agents maybe added to improve the speed and degree of separation.

4. Adjusting the pH of the solids and liquid phase to make them acceptable waste products; that is, products having a pH of 6-9 or more neutral.

The addition of calcium sulfate or calcium phosphate results in the co-precipitation of the protein, fat, and inorganic solids. The resulting solid has a density greater than one, which causes the solid phase to sink.

The chemicals used to process the waste stream do not degrade its value as a product and in some cases increase its value.

### EXAMPLES OF THE PROCESS

### Example 1

A dairy waste stream that contained high levels of fat and protein was treated in the following manner. This waste stream had a COD level of 150,000.

The pH was adjusted with a mixture of sulfuric acid and calcium sulfate to a pH of 4. The mixture was placed in a centrifuge, which separated the solid phase from the liquid phase. The pH of each phase was adjusted to 7. The solid phase is an acceptable feed supplement; that is, it has a low salt content which is low enough to be acceptable as cattle feed, and is high in protein. The liquid phase had a COD level of 30,000. The calcium and sulfate ions in the liquid phase have a low environmental impact on the water treatment plant; that is, the waste water had a low salt content acceptable to municipal authorities.

### Example 2

A waste stream that contained high levels of fat and protein was treated in the following manner.

The pH was adjusted with a mixture of sulfuric acid and calcium phosphate to a pH of 4. The mixture was placed in a centrifuge, which separated the solid phase from the liquid phase. The pH of each phase was adjusted to 7. The solid phase is a value added (i.e. higher price) feed supplement because it is fortified with calcium phosphate.

### Example 3

A waste stream that contained high levels of fat and protein was treated in the following manner.

The pH was adjusted with a mixture of phosphoric acid and calcium phosphate to a pH of 4.

The mixture was placed in a centrifuge, which separated the solid phase from the liquid phase. The pH of each phase was adjusted to 7. The solid phase is a value added feed supplement because it is fortified with calcium phosphate.

1. A process for treating waste water, comprising the following steps:
a. adding an acid to the waste water to adjust the pH of the waste water to less than 7;
b. adding a salt selected from the group consisting of calcium and magnesium;
c. separating the resulting solids from the liquid; and
d. adjusting the pH of the solids and liquid to make them acceptable waste products having a pH of 6-9.

2. The process of claim 1 wherein the pH is adjusted in step 1a to 5 to 3.

3. The process of claim 1 wherein the acid in step 1a is selected from the group consisting of sulfuric, phosphoric, and lactic acid.

4. The process of claim 1 wherein the salt in step 1b is incorporated in the acid solution in step 1a.

5. The process of claim 1 wherein the salt in step 1b is one with a polyvalent anion.

6. The process of claim 6 wherein the polyvalent anion salt is selected from the group consisting of sulfate and phosphate.

7. The process of claim 1 wherein a centrifuge is used for the separation in step 1c.

8. The process of claim 7 wherein flocculating agents are added in the separation step 1c.

9. A process for treating waste water, comprising the following steps:
a. adding a mixture of sulfuric acid and a salt selected from the group consisting of calcium phosphate and calcium sulfate to the waste water to adjust the pH of the waste water to 4;
b. separating the resulting solids from the liquid in the waste water; and
c. adjusting the pH of the solids and liquid to make them acceptable waste products having a pH of 6-9.

10. A process for treating waste water, comprising the following steps:
a adding a mixture of phosphoric acid and calcium phosphate to the waste water to adjust the pH of the waste water to 4;
b. separating the resulting solids from the liquid in the waste water; and
c. adjusting the pH of the solids and liquid to make them acceptable waste products having a pH of 6-9.
